(19) United States
(12) Patent Application Publication
(10) Pub. No.: US 2003/0149524 A1
(43) Pub. Date: Aug. 7, 2003

(54) Method and assembly for accumulating combined positional information for a system

(76) Inventors: Henning Lenz, Munich (DE); Dragan Obradovic, Munich (DE); Markus Schupfner, Regensburg (DE)

Correspondence Address: STAAS & HALSEY LLP, 700 11TH STREET, NW, SUITE 500, WASHINGTON, DC, 20001, US

(21) Appl. No.: 10/204,281

(22) PCT Filed: Dec. 21, 2000
(86) PCT No.: PCT/DE00/04604

(30) Foreign Application Priority Data
Feb. 21, 2000 (EP) 100 07 892.3

(51) Int. Cl. G01C 21/26

(52) U.S. Cl. 701/207; 701/214

(57) ABSTRACT

The invention relates to a method and an assembly for accumulating combined positional information for a system, in which for predetermined instants first and second respective positional information of a system are determined, using a first and a second position determination system. Respective error information for at least one part of the predetermined instants is determined using the first and second positional information. The error information is used to determine a measure for a statistical dependency between the respective error information, and said measure for a statistical dependency is used to determine the combined positional information.

The invention relates to a way of forming overall positional information, which overall positional information is determined by using a first position determination position and a second position determination system.

A way of forming overall positional information is known from [1], and is used there in a navigation system for determining positional information for a motor vehicle and for navigation of the motor vehicle.

The navigation system known from [1] comprises two redundant position determination systems, a first and a second position determination system.

The first and the second position determination systems are used in each case to determine for a current position of the motor vehicle current positional information, first positional information and second positional information, expressed in each case by a distance covered by the motor vehicle and an orientation of the motor vehicle.

The first positional information and the second positional information are used to determine overall positional information which describes the current position of the motor vehicle.

The motor vehicle is navigated by using the overall positional information.

The first position determination system of this navigation system comprises an odometer which is used to determine

the distance covered by the vehicle, and a gyroscope which is used to determine the orientation of the vehicle.

The second position determination system is a so-called global positioning system (GPS) which, just as with the first position determination system, is used to determine the distance covered and the orientation of the motor vehicle.

Known from [3] are further different types of systems of the GPS type, which differ in the way they determine positional information.

In the case of a determination of a current position of the motor vehicle, use is made of the current positional information both from the first position determination system (first positional information) and from the second position determination system (second positional information).

The two redundant sets of positional information are compared with one another so as to determine a difference in position between the first and the second positional information.

The current position is determined in such a way that the second positional information is used to correct the first positional information and the overall positional information for the current position of the motor vehicle is determined therefrom.

Otherwise, the overall positional information for the current position of the motor vehicle is formed only from the first positional information.

A Kalman filter is known from [2].

The invention is based on the problem of specifying a method and an arrangement which can be used to determine positional information of a system with better accuracy than in the case of the above-described methods.

The problem is solved by means of the method and by means of the arrangement in accordance with the respective independent patent claim.

In the case of the method for forming overall positional information for a system, which overall positional information is determined by using a first position determination system and a second position determination system, first positional information of the system is determined for prescribed instants by using the first position determination system. Second positional information of the system is determined for the prescribed instants by using the second position determination system.

Error information is determined in each case for at least a portion of the prescribed instants by using the first and the second positional information of the respective instant.

A measure of a statistical dependence between the items of error information is determined and the overall positional information is determined by using the measure of the statistical dependence.

The arrangement for forming overall positional information for a system, which overall positional information is determined by using a first position determination system and a second position determination system, has a processor that is set up in such a way that

first positional information of the system can be determined for prescribed instants by using the first position determination system,

second positional information of the system can be determined for the prescribed instants by using the second position determination system,

error information can be determined in each case for at least a portion of the prescribed instants by using the first and the second positional information of the respective instant,

a measure of a statistical dependence between the items of error information can be determined and the overall positional information can be determined by using the measure of the statistical dependence.

The arrangement is particularly suitable for carrying out the method according to the invention or one of its subsequently explained developments.

It may be pointed out, furthermore, that a measure of a statistical dependence is also to be understood in a wider sense as a statistical measure of an error. Furthermore, not only is a measure to be understood as a discrete number or a discrete value, but a measure may also be a functional description or a continuous variable.

Preferred developments of the invention follow from the dependent claims.

The developments described below relate both to the method and to the arrangement.

The invention and the developments in the further description can be implemented in both software and in hardware, for example by using a specific electric circuit.

Furthermore, an implementation of the invention or of a development described below is possible by means of a computer-readable storage medium on which there is stored a computer program that executes the invention or development.

Again, the invention and/or each development described below can be implemented by means of a computer program product that has a storage medium on which there is stored a computer program that executes the invention and/or development.

Error information is preferably determined in each case for all prescribed instants in order to improve accuracy of the overall positional information.

In one development, the first and the second positional information respectively comprises a distance covered by the system and an orientation of the system.

The first and the second positional information can also respectively comprise a speed of the system.

The prescribed instants describe a time series in the case of one refinement in which the overall positional information is determined during operation of the system.

In one development, the first positional information and/or the second positional information are/is determined for a future instant by using the measure of the statistical dependence. The first and/or the second positional information is corrected for one of the prescribed instances by using the first and/or the second positional information for the future instant, and the overall positional information is formed thereby.

In order further to improve the accuracy of the overall positional information, a measure of the statistical dependence is preferably determined by using a Kalman filter.

In one development, the measure of the statistical dependence is derived from a covariance matrix that is formed by using the error information.

In one refinement, a reliability check is carried out for the first and/or the second positional information by using the measure of the statistical dependence.

In order to improve navigation of a system to be navigated, for example a motor vehicle, use is made of a development in a navigation system with the aid of which a position of the system to be navigated is determined.

In the case of a cost-effective development, the first position determination system preferably comprises an odometer and a gyroscope.

A global positioning system (GPS) is preferably used as a second position determination system.

Exemplary embodiments of the invention are illustrated in figures and are explained in further detail below.

In the figures:

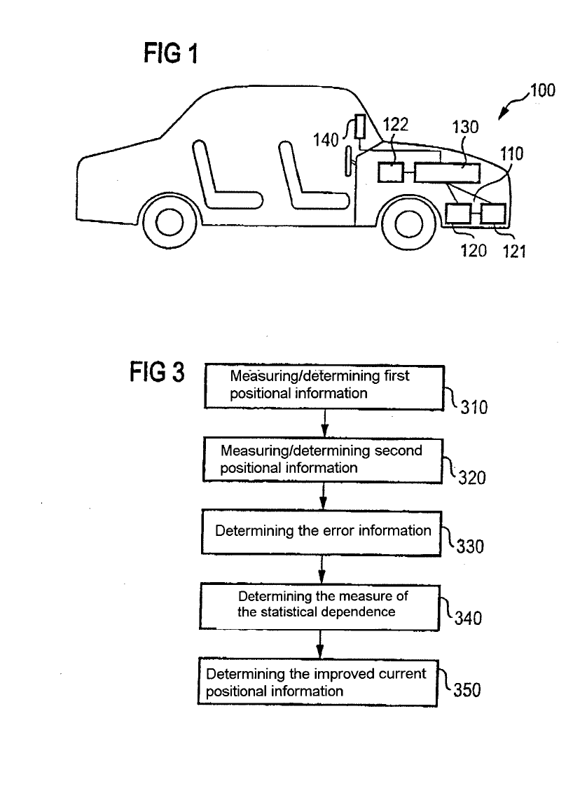

FIG. 1 shows a sketch of a navigation system with components in a motor vehicle;

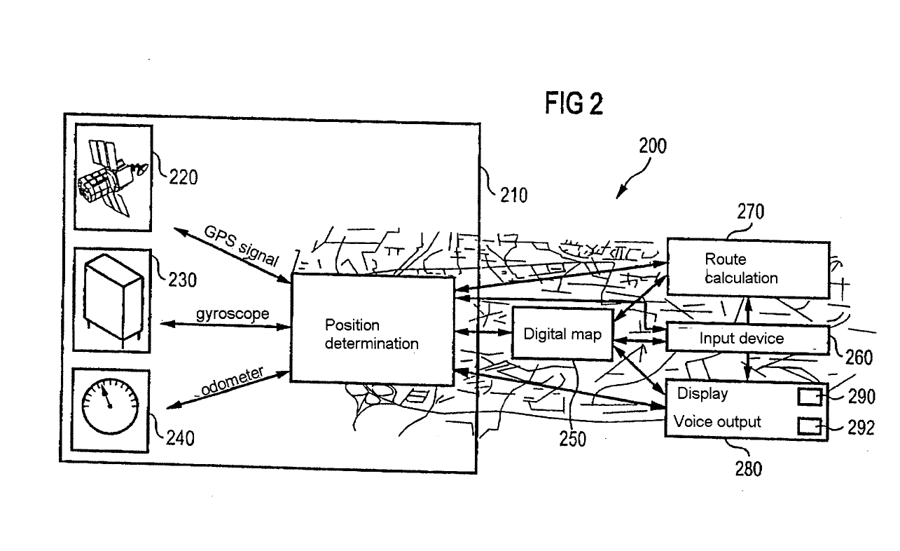

FIG. 2 shows a sketch that describes cooperation of components of a navigation system;

FIG. 3 shows a sketch of method steps in a method for determining positional information, and

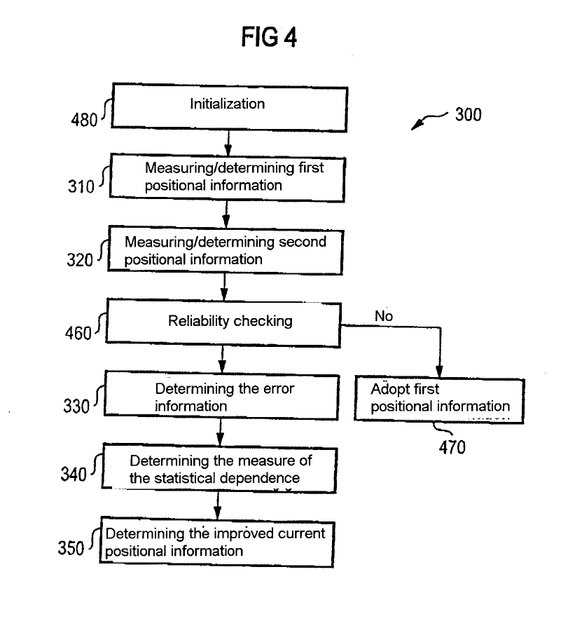

FIG. 4 shows a sketch of method steps in accordance with an alternative to the exemplary embodiment.

Exemplary embodiment: Navigation system in a motor vehicle

FIG. 1 shows a motor vehicle 100 that is equipped with a navigation system 110.

Components of this navigation system 110 are illustrated in FIG. 1 and FIG. 2 and described below.

How the components of the navigation system 110 cooperate is illustrated schematically in FIG. 2.

The components of the navigation system 200 are interconnected in each case with connections in such a way that data that is determined or measured in the individual components can be transmitted into the other components, and be available there for further processing.

The connections between the components of the navigation system 200 are illustrated in FIG. 2 by means of arrows, an arrow direction illustrating a direction of transmission of the data between two interconnected components.

The navigation system 200 comprises a position determination system 210, which in turn has three independent position determination systems, a GPS system 220, a gyroscope 230 and an odometer 240.

The current, first positional information of a current position of the motor vehicle is determined by using the gyroscope 230 and the odometer 240.

The second current positional information, that is redundant relative to the first positional information, is determined by using the GPS system 220.

The current positional information for the current position of the motor vehicle 100 that is improved, because it is more accurate, is determined by using the first positional information and the second positional information, that is redundant further thereto.

A digital map 250 is stored in the navigation system 200. The digital map 250 is a digitized image of the surroundings of the motor vehicle 100 in which traffic connections and other traffic-relevant information, for example towns, are entered.

The current position of the motor vehicle in the digital map 250 is determined by using the digital map 250 and the improved current positional information of the motor vehicle 100.

The navigation system 200 has an input device 260 with the aid of which a destination position of the motor vehicle 100 can be input into the navigation system 200 by a driver of the motor vehicle 100.

A route calculation unit 270 of the navigation system 250 determines a route with the shortest possible driving distance to the destination position by using the input destination position and the improved, current position of the motor vehicle.

It may be pointed out that it is also possible to calculate a route that is optimum with regard to another criterion, for example driving time.

The navigation system 200 has a display unit 280. The route with the shortest possible driving distance (or other optimum routes) to the input destination position is displayed to the driver of the motor vehicle 100 acoustically and optically by using the display unit 280, which comprises an optical output means 290 and an acoustic output means 291.

FIG. 1 shows the gyroscope 120, the odometer 121 and the GPS 122, which are respectively connected via data lines 123 to an arithmetic-logic unit 130.

It may be pointed out that a data line can also be a radiolink or other medium.

Stored in the arithmetic-logic unit 130 is a digital map and a first software program that is described below and by using which the improved, current positional information of the motor vehicle is determined.

Stored in the arithmetic-logic unit 130 is a second software program, with the aid of which the current position of the motor vehicle in a digital map is determined, and the route with the shortest driving distance to the prescribed destination position is determined by using the current position.

FIG. 1 shows the input means 140 for inputting the destination position of the motor vehicle, and the output means for outputting the route with the shortest possible driving distance to the destination position.

Method steps 300 for determining the improved current positional information for the current position of the motor vehicle are illustrated in FIG. 3.

The method steps described below are carried out continuously during operation of the navigation system 110 or 200.

The first positional information of the motor vehicle 100 is determined and/or measured in each case in a first method step 310 for prescribed instants k of a time series by using the first position determination system, the gyroscope and the odometer.

a) Gyroscope

A gyroscope measures a measured value vGyro(k) at the instance k. The following formal relationships can be described thereby:

wWin(k)=[vGyro(k)−(v0Gyro(k)+p1(k))]*s(k) (1)

$$\begin{matrix}W1 ( k + 1 ) = W1 ( k ) + wWin ( k ) dt = & ( 2 ) \\ = W1 ( k ) + [ [ vGyro ( k ) - ( v0Gyro ( k ) + p1 ( k ) ) ] * s ( k ) ] dt & ( 3 )\end{matrix}$$

p1(k+1)=p1(k) (4)

where:

wWin( . . . ): change in angle,

s( . . . ): scaling factor,

v0Gyro( . . . ): gyroscope offset,

W1( . . . ): orientation,

P1( . . . ): gyroscope parameter,

dT: clock.

and with the aid of k and k+1, which describe an instant (k) and an instant (k+1), later by one time step, of a time series having instants, there being a time step of 0.5 sec in each case between two instants of the time series.

b) Odometer

The odometer measures a measured value v0do(k) at the instant k. The following formal relationships can be described thereby:

wOdo(k)=vOdo(k)*[t(k)+p2(k)]*dT (5)

p2(k+1)=p2(k) (6)

where:

wOdo( . . . ): distance covered,

vOdo( . . . ): speed,

t( . . . ): scaling factor,

p2( . . . ): odometer parameters.

The first positional information therefore comprises the variable W1(k) and the variable wOdo(k).

It follows from the formal relationships (1)-(6) that:

u(k)=[v0Gyro(k), s(k), t(k)] (7)

x(k)=[W1(k), p1(k), p2(k)] (8)

y(k)=[W1(k), wOdo(k)] (9)

The second positional information of the motor vehicle 100 is determined in a second method step 320 for the prescribed instants k of the time series by using the second position determination system.

It may be pointed out that in the case of a different clock with the aid of which the measured values are measured by the position determination system, it is necessary, if appropriate, to carry out an interpolation of the measured values of a position determining system such that the measured values and the interpolated measured values relate in each case to the same instants.

However, if the instants of the measured values of the positioned determination systems differ only slightly, it is possible, if appropriate, to dispense with an interpolation. In this case, however, slight inaccuracies in the determination of position must be accepted.

The GPS measures the following variables at the instant

k:

W2(k): orientation,

wGPS(k): speed.

The second positional information relating to an instant k therefore comprises the variable W2(k) and the variable wGPS(k), which are combined to form a GPS position vector GPS(k)=[W2(k), wGPS(k)].

In a third method step 330, error information is determined for all prescribed instants k of the time series, making use in each case of the first and the second positional information of the respective instant, this being done in such a way that a difference is determined between the respective first and second positional information.

A time series for the error information is thereby determined.

It may be pointed out that the time series begins at the instant k=0, this being taken to mean commissioning of the navigation system 110 or 200.

Formal relationships of the third 330 method step are described in the case of a later method step because of better comprehensibility.

In a fourth method step 340, a measure is determined for a statistical dependence between the instances of error information.

Formal relationships of the fourth 340 method step are described in a later method step on the basis of better comprehensibility.

The improved current positional information for the current position of the motor vehicle is determined in a fifth method step 340 and by using the measure of the statistical dependence between the instances of error information.

The third 330, the fourth 340 and the fifth 350 method steps are implemented by using a Kalman filter or formal relationships based on the Kalman filter, which filter or relationships is or are described in [2].

It holds, furthermore, that an index z respectively characterizes an estimate or prediction of the associated variable denoted by the index z.

It also holds, furthermore, that an index T respectively denotes a transposed variable of the variable characterized thereby.

The measure of the statistical dependence, in this case of a temporal error statistic, is an error covariance matrix P(k) in this case.

The following formal relationships hold:

x(k+1)=f(x(k), u(k))+Q(k) (10)

y(k) g(x(k), u(k))+R(k) (11)

where:

Q( . . . ) : covariance matrix for noise,

R( . . . ): covariance matrix for noise.

The following formal relationships also hold:

xz(k+1)=f(x(k), u(k)) (12)

Pz(k+1)=A(k)*P(k)*AT(k)+Q(k) (13)

where:

f( . . . ): nonlinear system description,

A( . . . ): system matrix, A=δf/δx.

It holds, furthermore, that:

K(k)=Pz(k)*CT(k)*[C(k)*Pz(k)*CT(k)+exp(dT/ff)*R(k)]−1 (14)

x(k)=xz(k)−K(k)*[GPS(k)−g(x(k), u(k))] (15)

P(k)=exp(dT/ff)*(I−K(k)*C(k))*Pz(k) (16)

where:

K( . . . ): gain,

I: unit matrix,

dT/ff: factor,

C( . . . ): output matrix, C=δg /δx.

$$\begin{matrix}A = [ \begin{matrix}1 & gscal ( k ) * dT & 0 \\ 0 & 1 & 0 \\ 0 & 0 & 1\end{matrix} ] & ( 17 ) \\ C = [ \begin{matrix}1 & 0 & 0 \\ 0 & 0 & odopulse ( k )\end{matrix} ] & ( 18 )\end{matrix}$$

After the method steps have been carried out, the vector y(k) has the improved current overall positional information that is used to navigate the motor vehicle 100 by using the navigation system 110.

It may be pointed out that using the navigation system is not limited to a motor vehicle but that the navigation system can also be used, given an appropriate adaptation, for any other mobile, but also non-mobile system, for example, a maritime vehicle, an aircraft or a building.

It is pointed out, furthermore, that it is also possible to use other position determination systems than those which are described in the exemplary embodiment for overall position determination in accordance with the method having the features in accordance with the independent claim or one of the said developments.

However, using position determination systems as in the case of the exemplary embodiment, a gyroscope and an odometer (first position determination system) and a GPS (second position determination system) has the great advantage that it is thereby possible to describe a position of a motor vehicle by using mutually independent variables, specifically the distance covered by the motor vehicle and the orientation of the motor vehicle.

This leads to the production of particularly simply structured matrices, for example the matrices A, C, P and K in the determination of the error information. This simple structure is used during the implementation in order to reduce the computational outlay to approximately one quarter by executing in place of a complete matrix calculation only the multiplications and additions that are necessary.

In an alternative to the exemplary embodiment that is illustrated in FIG. 4, a sixth method step 460 is provided that is carried out between the second 320 method step and the third 330 method step, and in which the second positional information GPS(k) is checked for reliability.

The checking of the reliability is performed using the following logic:

WGPS(k)>Sw (19)

DOP(k)>Sdop (20)

AS(k)>Ssat (21)

Tas(k)>St (22)

where:

Sw, Adop, Ssat, St: threshold values, can also be time dependent,

DOP( . . . : geometry of a current satellite constellation,

AS( . . . ): number of available satellites,

Tas( . . . ): period of time for AS(k)>Ssat.

If all four inequalities (19)-(22) are satisfied, the second positional information GPS(k) is evaluated as reliable.

Only if the second positional information has been assessed as reliable are the subsequent method steps, the third 330, the fourth 340 and the fifth 350 method steps, carried out.

If the second positional information is assessed as unreliable, the first positional information is adopted in a seventh method step 470 as the improved current overall position.

Furthermore, in the case of the alternative an initialization step 480 is provided that is carried out before the first method step 310 and in which variables of the method are initialized. The following publications have been cited in this document:

[1] Zhao Yilin: “Vehicle Location and Navigation Systems”, Artech House Publishers, pages 43-104, pages 239-264, 1997, ISBN 0-89006-8621-5.

[2] Brammer, Siffling: “Kalma-Bucy-Filter”, Oldenbourg-Verlag, Munich pages 75-111, 4th edition, 1994.

[3] Zhao Yilin: “Vehicle Location and Navigation Systems”, Artech House Publishers, pages 63-75, 1997, ISBN 0-89006-8621-5.

1. A method for forming overall positional information for a system, which overall positional information is determined by using a first position determination system and a second position determination system,
in which first positional information of the system is determined for prescribed instants by using the first position determination system,
in which second positional information of the system is determined for the prescribed instants by using the second position determination system, and
in which error information is determined in each case for at least a portion of the prescribed instants by using the first and the second positional information of the respective instant, characterized in that
a measure of a statistical dependence between the items of error information is determined and the overall positional information is determined by using the measure of the statistical dependence.

2. The method as claimed in claim 1, in which error information is determined in each case for all prescribed instants.

3. The method as claimed in claim 1 or 2, in which the first and the second positional information respectively comprises a distance covered by the system and/or a speed of the system and/or an orientation of the system.

4. The method as claimed in one of claims 1 to 3, in which the prescribed instants describe a time series.

5. The method as claimed in one of claims 1 to 4, in which the first positional information and/or the second positional information are/is determined for a future instant by using the measure of the statistical dependence.

6. The method as claimed in claim 5, in which the first and/or the second positional information is corrected for one of the prescribed instants by using the first and/or the second positional information for the future instant, and the overall positional information is formed thereby.

7. The method as claimed in one of claims 1 to 6, in which the measure of the statistical dependence is determined by using a Kalman filter.

8. The method as claimed in one of claims 1 to 7, in which the measure of the statistical dependence is derived from a covariance matrix that is formed by using the error information.

9. The method as claimed in one of claims 1 to 8, in which a reliability check is carried out for the first and/or the second positional information by using the measure of the statistical dependence.

10. The method as claimed in one of claims 1 to 9, used in a navigation system with the aid of which a position of a system to be navigated is determined.

11. An arrangement for forming overall positional information for a system, which overall positional information can be determined by using a first position determination system and a second position determination system, which arrangement has a processor that is set up in such a way that
first positional information of the system can be determined for prescribed instants by using the first position determination system,
second positional information of the system can be determined for the prescribed instants by using the second position determination system,
in which error information can be determined in each case for at least a portion of the prescribed instants by using the first and the second positional information of the respective instant,
characterized in that the processor is set up such that
a measure of a statistical dependence between the items of error information can be determined and the overall positional information can be determined by using the measure of the statistical dependence.

12. The arrangement as claimed in claim 11, in which the first position determination system comprises an odometer and a gyroscope.

13. The arrangement as claimed in claim 11 or 12, in which the second position determination system is a GPS system.

14. The arrangement as claimed in one of claims 11 to 13, in which the system is a motor vehicle.
